(19) United States
(12) Patent Application Publication
(10) Pub. No.: US 2007/0050208 A1
(43) Pub. Date: Mar. 1, 2007

(54) Methods and systems for health care resource management

(76) Inventors: John Bardis, Alpharetta, GA (US); Neil Hunn, Alpharetta, GA (US); Randy Sparkman, Cape Girardeau, MO (US); David Evans, Atlanta, GA (US); Kate Banks, Atlanta, GA (US); Patrick Buckley, Atlanta, GA (US)

Correspondence Address: KILPATRICK STOCKTON LLP, 1001 WEST FOURTH STREET, WINSTON-SALEM, NC, 27101, US

(21) Appl. No.: 11/408,414

(22) Filed: Apr. 21, 2006

Related U.S. Application Data
(60) Provisional application No. 60/673,596, filed on Apr. 21, 2005.

(51) Int. Cl. G06Q 50/00

(52) U.S. Cl. 705/2

(57) ABSTRACT

Methods and systems for health-care resource management are described. One described method includes associating provision data with a charge item in a standardized chargemaster data store arranged as a hierarchy. The provision data is associated with provision of a health care-related service by a health-care provider and with a product identifier that is associated with a product. The method also includes associating the charge item with a purchasable item in a standardized item master data store, the purchasable item associated with the health care-related service, associating purchase data with the standardized item master data store, the purchase data associated with the health-care related service, and associating the provision data with the purchase data based at least in part on the hierarchy of the standardized chargemaster.

### CROSS-REFERENCE TO RELATED APPLICATIONS

The application claims priority to U.S. Provisional Application No. 60/673,596, filed Apr. 21, 2005, entitled “Methods and Systems for Health Care Resource Management,” the entirety of which is incorporated herein by reference.

### FIELD OF THE INVENTION

The present invention relates generally to resource management and, more particularly, to methods and systems for health care resource management.

### BACKGROUND

Health care providers, including, for example, hospitals and medical clinics, provide a myriad of health care services to patients. During provision of these health care services, the health care facilities use various medical items, including consumable products. Health care facilities purchase these products by the thousands every year.

Although the health care facility purchases the products, they are in a unique situation in that unlike other purchasers, health care facilities do not control how the products they purchase are used. In addition, the products used by a healthcare facility change on a frequent basis. A third party, typically a physician, controls use of the products. The physician determines what is in the best interest of a particular patient and orders products and procedures to be used based on that determination. The products used for the care of a patient are generally not billed for until after a patient has been discharged from the health care facility. Often, the data captured for the products provided is captured at a different level of detail (e.g., with less specificity) than what is captured when the products are purchased.

Accordingly, it may be difficult to automatically link the provision data with the purchase data. Further, in health care facilities, the purchasing and provision or charge systems are often not capable of communicating with one another. Thus, linking of the data in order to determine the actual cost of products provided during the provision of health care services is difficult.

### SUMMARY

Embodiments of the present invention provide methods and systems for health care resource management. One method for health-care resource management according to one embodiment of the present invention comprises associating provision data with a charge item in a standardized chargemaster data store arranged as a hierarchy. The provision data is associated with provision of a health care-related service by a health-care provider and with a product identifier that is associated with a product. The method in the embodiment further comprises associating the charge item with a purchasable item in a standardized item master data store, the purchasable item associated with the health care-related service, associating purchase data with the standardized item master data store, the purchase data associated with the health-care related service, and associating the provision data with the purchase data based at least in part on the hierarchy of the standardized chargemaster.

This illustrative embodiment is mentioned not to limit or define the invention, but to provide one example to aid understanding thereof. Illustrative embodiments are discussed in the Detailed Description, and further description of the invention is provided there. Advantages offered by the various embodiments of the present invention may be further understood by examining this specification.

### FIGURES

These and other features, aspects, and advantages of the present invention are better understood when the following Detailed Description is read with reference to the accompanying drawings, wherein:

FIG. 1 is a block diagram showing an illustrative environment for implementation of one embodiment of the present invention;

FIG. 2 is a data table 200 illustrating health care purchase data in one embodiment of the present invention;

FIG. 3 is a data table illustrating items used during the provision of health care in one embodiment of the present invention;

FIG. 4 is a flowchart illustrating a process for linking healthcare provision data and corresponding purchase data in one embodiment of the present invention;

FIG. 5 is a flowchart illustrating another process for linking healthcare provision data and corresponding purchase data in one embodiment of the present invention;

FIG. 6 is a block diagram, illustrating a charge hierarchy in one embodiment of the present invention;

FIG. 7 is a flowchart illustrating the creation of a supply-revenue link report provided in one embodiment of the present invention;

FIG. 8 is a screen shot illustrating a markup analysis report in one embodiment of the present invention;

FIG. 9 is a screen shot illustrating a unlinked supply items report in one embodiment of the present invention;

FIG. 10 is a screen shot illustrating a unlinked charge items report in one embodiment of the present invention;

FIG. 11 is a screen shot illustrating a cost-to-charge analysis report in one embodiment of the present invention;

FIG. 12 is a screen shot illustrating a chargemaster benchmark report in one embodiment of the present invention;

FIGS. 13-15 are screen shots illustrating a markup simulation tool in one embodiment of the present invention; and

FIG. 16 is a screen shot illustrating an interface for viewing at what level an item in the facility charge master is linked to in one embodiment of the present invention.

### DETAILED DESCRIPTION

### Introduction

Embodiments of the present invention comprise methods and systems for health care resource management. There are multiple embodiments of the present invention. By way of introduction and example, one illustrative embodiment of the present invention provides a method for automatically linking closed receipts data, reflecting purchases made by the hospital, and chargemaster data, reflecting charges to patients for products and services utilized during the provision of health care services.

In one embodiment, a hospital purchases items, such as health care products, which are to be used for providing health care to patients. The items may include, for example, catheters. The item purchases, including item descriptions, quantities, and prices, may be captured in the hospital's inventory management system or outside the inventory management system. Generally, the inventory management systems include a closed receipts data store, which includes information about the items purchased in inventory in the hospital. Data captured outside the inventory management system is typically referred to as facility item master data. The closed receipts data store may be stored in a database, such as a relational database, in a file, or in some other data store. The closed receipts data store may also be referred to as the hospital item master, facility item master, client item file, or item file. In one embodiment, the system obtains all cost and purchased quantity data from the closed receipts which are obtained from the inventory management system,

The inventory management systems may also be linked to a resource management system that includes a best practice item master data store. The best practice item master data store associates items in the item master data store with standard attributes for these items, i.e., it is a standardized item master data store. The standard attributes may be used in multiple health care facilities or industry wide. For example, the best practice item master data store may include a unique identifier for a particular type and size of catheter. The best practice data store may also have the correct unit or measure (UOM) and/or UOM conversion so that the appropriate cost on a per use basis (as reflected in the chargemaster) can be determined. The item master data store and best practice item master data store are linked. The best practice item master data store also facilitates linking item or cost-related data to charge-related data in a best practice chargemaster data store, which is a standardized chargemaster data store. The best practice item master data store may also be referred to as a best practice item master or parent item master data store.

A physician, who is a third party and not typically an employee of the hospital, supervises care of a patient. During provision of care to the patient, the physician and other health care providers use items that were previously purchased by the hospital and recorded in the closed receipts data store. For example, the physician may order that the patient be catheterized. An indication of the catheterization is made on the patient's chart.

The hospital has a charge system including a chargemaster data store for tracking charges to the patient. The chargemaster data store includes records of what products and services were utilized during the patient's stay in the hospital. In embodiments of the present invention, the chargemaster data store may also be referred to as a facility chargemaster, a hospital chargemaster, or a charge file. Typically, coding and diagnostic data is not entered into the hospital's charge system during the patient's stay at the hospital. Rather, this data is entered into the chargemaster data store after the patient is discharged from the hospital. However, supply data may be entered before the patient is discharged. For example, supply charges are often posted when the supplies are used but in some instances, may be entered post discharge. The chargemaster is linked to the best practice chargemaster file.

A software program or combination of software programs links the hospital's closed receipts data store with the best practice item master. Closed receipts may also be linked to the facility's item master so that cost data can be associated with each item in the item file. In one embodiment, any item that has been successfully linked to the best practice item master and not linked to an item in the facility item master is designated as a non-file item (i.e., an item that has been purchased outside of the materials management system). The software also links the chargemaster data with the best practice chargemaster data store. This link allows the closed receipts and/or facility item data to be linked. An added benefit is the facility's ability to leverage the hierarchy of the best practice chargemaster. Also, linking of the facility chargemaster with the best practice chargemaster fosters data integrity and consistency. The software receives the chargemaster data entered after the patient is discharged and determines an item associated with the data. In the case above, the software determines that the chargemaster data is associated with a catheter, i.e., the patient was catheterized. The software then determines attributes associated with the charge based on the description of the charge, such as, for example, the product name or identifier, a uniform product code, a description, a size, or a purchase date. The software uses the charge attributes to determine a purchased item in the closed receipts data store with which to automatically link the chargemaster data in the chargemaster data store. The link may be direct or may be indirect or virtual, i.e., the link may be between the chargemaster and best policy chargemaster, the closed receipts and best policy item master, and between the best policy item master and best policy charge master.

For example, the software determines that a particular type of catheter was used for the patient based on the description of the catheter entered on the chart and subsequently recorded in the chargemaster data store. The software then links the catheter in the chargemaster data store, directly or virtually, with a corresponding catheter in the closed receipts or facility item master data store. In one embodiment, if an item appears in the facility item master, the chargemaster is linked to the facility item master and the chargemaster is linked to the closed receipts only if an item does not appear in the facility item master. In such an embodiment, the facility item master is then linked to the closed receipts, which provides cost and purchase quantity data. The linking of the best practice data structures to the closed receipts or facility item master data is leveraged every time the hospital data is updated so that new updated links can be generated very quickly and data integrity is preserved and enhanced over time.

Once the chargemaster data and closed receipts and/or facility item master data are linked, reports detailing the actual cost of items utilized during provision of the health care service may be provided to hospital administrators or others. Thus, in the example above, the cost of providing services to the patient who was catheterized can be determined accurately and on a patient-by-patient basis by linking the catheter purchase information with the chargemaster data. Other information may be provided as well, such as the markup amounts for individual items. Using this type of data, quantitative analysis may be performed. The data may also be reported at a summary level for all patients during a specified period.

By utilizing standardized item master and chargemaster data stores, embodiments of the present invention provide a scalable approach to linking the provision of healthcare services and corresponding supplies with the purchase of items necessary to provide these services. Such embodiments tend to keep the linkages between provision and purchases from eroding over time as may occur in conventional systems. Also, the linkages provided by the methods and systems described herein may be utilized by various hospital management and reporting systems.

This introduction is given to introduce the reader to the general subject matter of the application. By no means is the invention limited to such subject matter. Illustrative embodiments are described below.

### System Architecture

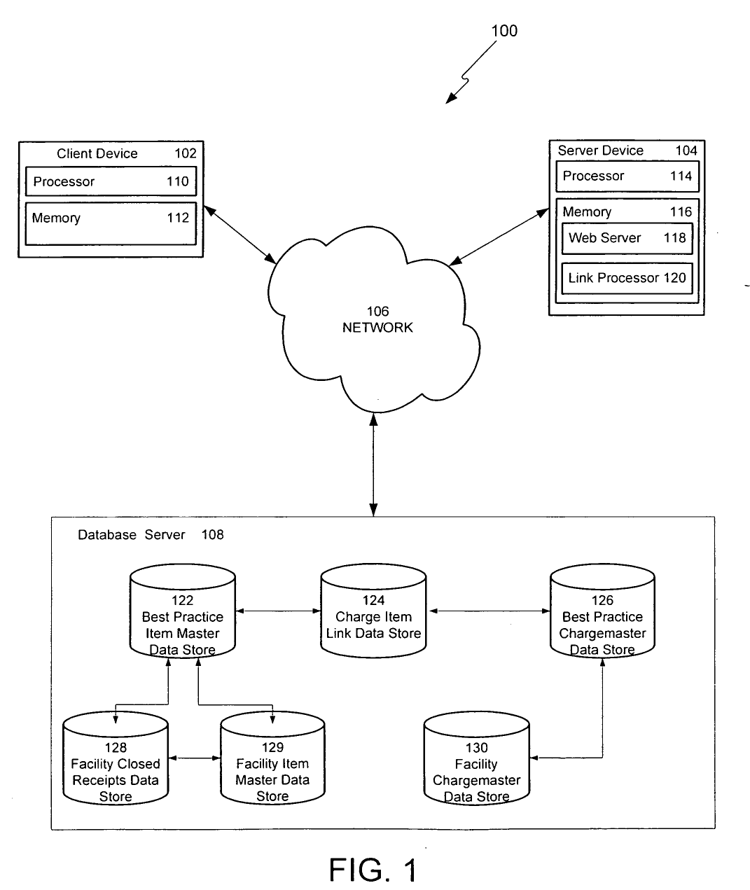

Various systems in accordance with the present invention may be constructed. Referring now to the drawings in which like numerals indicate like elements throughout the several figures, FIG. 1 is a block diagram showing an illustrative environment for implementation of one embodiment of the present invention. The system 100 shown in FIG. 1 comprises a client device 102 in communication with a server device 104 and a database server 108 over a network 106. In one embodiment, the network 106 shown comprises the Internet. The network may also comprise an intranet, a Local Area Network (LAN), a telephone network, or a combination of suitable networks. The client device 102 and the server devices 104, 108 may connect to the network 106 through wired, wireless, or optical connections.

In one embodiment, the server device 104 can contain a web server 118. The web server 118 provides documents indexed and stored by a search engine (not shown) in response to requests from the client device 102. The web server 118 may provide static and dynamic web pages.

For example, if the client 102 submits a request to the web server 118 for information related to data stored in data store 108, the web server 118 may execute a query against tables in the data store 108. The data store 108 responds with a record set containing data records satisfying the request from the web server 118. The web server 118 then formats the record set as HTML, XML, or some other suitable format and returns the formatted data to the client 102.

### Client Devices

Examples of client device 102 are personal computers, digital assistants, personal digital assistants, cellular phones, mobile phones, smart phones, pagers, digital tablets, laptop computers, Internet appliances, and other processor-based devices. In general, a client device 102 may be any suitable type of processor-based platform that is connected to a network 106 and that interacts with one or more application programs.

The client device 102 can contain a processor 110 coupled to a computer readable medium, such as memory 112. Client device 102 may operate on any operating system capable of supporting a browser or browser-enabled application, such as Microsoft® Windows® or Linux. The client device 102 is, for example, a personal computer executing a browser application program such as Microsoft Corporation's Internet Explorer™, Netscape Communication Corporation's Netscape Navigator™, Mozilla Organization's Firefox, Apple Computer, Inc.'s Safari™, Opera Software's Opera Web Browser, and the open source Linux Browser.

### Server Devices

The server device 104 contains a processor 114 coupled to a computer-readable medium, such as memory 116. The memory comprises applications, such as a web server 118 and a link processor 120. The link processor 120 comprises program code for automatically determining links between provision or charge data and purchase or item master data. Although illustrated as a single processor, the link processor 120 may comprise a combination of several software programs and/or hardware configurations. The chargemaster data details charges to patients to whom health care services are provided. The item master data details purchases of products used for the provision of health care. Although described in terms of program code, the processes described herein may be implemented as special purpose processors as well.

Web server 104 stores documents and processes requests from the client 102. Program code running on the web server 108 may include web server software, such as the open source Apache Web Server and the Internet Information Server (IIS) from Microsoft Corporation.

Database server 108 contains a computer readable medium storage device, such as a magnetic or optical disk storage device, on which are stored tables 122-130. The database server 108 includes a data store management system, such as the Oracle®, SQLServer, or MySQL relational data store management systems, which allows the database server 108 to provide data in response to queries.

Server devices 104, 108, which are depicted as single computer systems, may be implemented as a network of computer processors. Examples of server devices 104, 108 are a server, mainframe computer, networked computer, or other processor-based devices, and similar types of systems and devices. Client processor 110 and server processor 114 can be any of a number of computer processors, as described below, such as processors from Intel Corporation of Santa Clara, Calif. and Motorola Corporation of Schaumburg, Ill.

Such processors may include a microprocessor, an ASIC, and state machines. Such processors include, or may be in communication with computer-readable media, which stores program code or instructions that, when executed by the processor, cause the processor to perform actions. Embodiments of computer-readable media include, but are not limited to, an electronic, optical, magnetic, or other storage or transmission device capable of providing a processor, such as the processor 114 of server device 104, with computer-readable instructions. Other examples of suitable media include, but are not limited to, a floppy disk, CD-ROM, DVD, magnetic disk, memory chip, ROM, RAM, an ASIC, a configured processor, optical media, magnetic tape media, or any other suitable medium from which a computer processor can read instructions. Also, various other forms of computer-readable media may transmit or carry program code or instructions to a computer, including a router, private or public network, or other transmission device or channel, both wired and wireless. The instructions may comprise program code from any computer-programming language, including, for example, C, C++, C#, Visual Basic, Java, Python, Perl, and JavaScript.

It should be noted that the present invention may comprise systems having a different architecture than that which is shown in FIG. 1. For example, in some systems according to the present invention, database server 108 may be contained in memory 116. The system 100 shown in FIG. 1 is merely illustrative, and is used to help explain the illustrative systems and processes discussed below.

### Health Care Resource Management

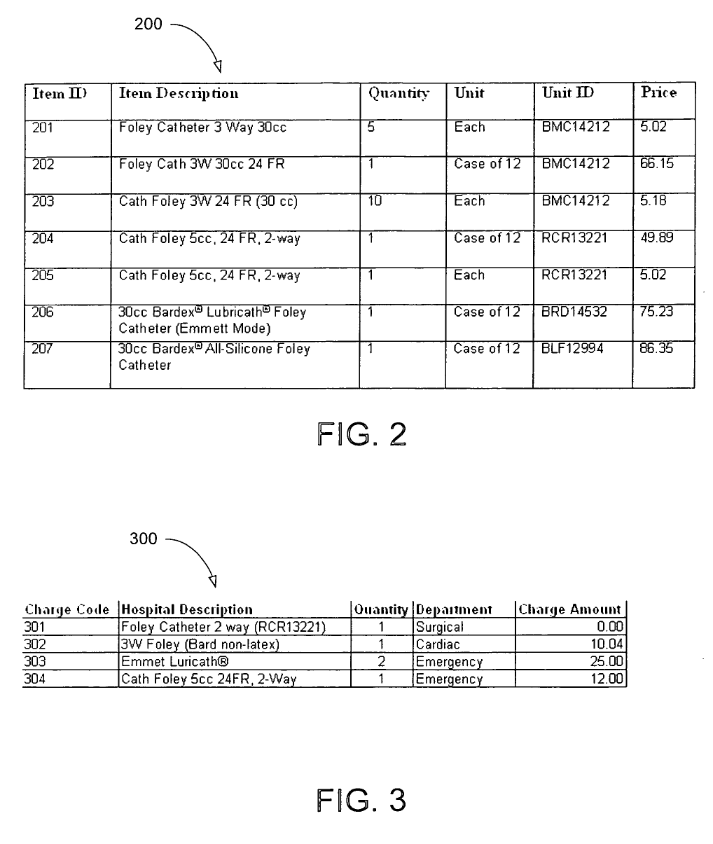

Embodiments of the present invention provide systems and methods for health care resource management, including the linking of health care item and chargemaster data. FIG. 2 is a data table 200 illustrating health care purchase data in one embodiment of the present invention. Health care purchase data may also be referred to herein as closed receipts or item master data. Closed receipts data may be stored in a closed receipts data store. Closed receipts data are linked to a best practice item master store. In addition closed receipts are also linked to a facility item master data store so the most accurate cost and purchased quantity can be obtained for that item. Any closed receipt that cannot be linked with an item in the facility item master is likely an item being purchased outside of the materials management system. It is in a hospital's best interest to know which items are being purchased outside of the materials management system so that they can be added to the facility item master so that they have greater control on what's being spent.

The closed receipts data in data table 200 includes an item identifier (Item ID), description (Item Description), quantity purchased (Quantity), which may be referred to as volume, unit of measure for the quantity purchased (Unit), an identifier, such as a manufacturer or distributor item identifier (Unit ID), and a price paid per unit (Price). In some embodiments, the data shown in FIG. 2 may be retrieved from the facility item master or from a combination of the closed receipts and facility item master data stores.

The data in FIG. 2 represents purchases of a variety of Foley catheters. The catheters are available in a variety of sizes and also available in latex and non-latex materials. Some of the items include, for example, 3-way, 30 CC Foley catheters (items 201-203). While these three items are essentially the same, the item description varies. The variability of the order and makeup of the description complicates the process of linking this data with chargemaster data. For instance, while some descriptions may include a product that is spelled out, e.g., “Foley catheter,” other descriptions will include synonyms or abbreviations, e.g., “cath-foley.” Further, the description may include additional information, such as a manufacturer name or identifier, which is not included in all item descriptions. Also, some descriptions may include properties of the product, such as the material from which the product is made. This information may affect the price or otherwise affect the linking of closed receipts and chargemaster data.

The items purchased may also be packaged differently. For instance, while items 204 and 205 share a common description, “Cath-Foley 5 cc, 24 Fr, 2-way,” they differ in packaging. One embodiment of the present invention performs UOM conversions so that items purchased in differing packaging can be linked so that accurate costs can be determined. Items 206 and 207 include in the item descriptions, the trade names for the catheters. Item 207 is an all-silicone Foley catheter. This may also be referred to as a latex-free catheter, which is used, among other reasons, when a patient is allergic to latex.

FIG. 3 is a data table illustrating products used during the provision of health care, which is referred to herein as chargemaster data or provision data. The data table 300 includes four records. Each of these records relates to use of a Foley catheter during provision of a health care service. The table includes the item identifier (Item ID), which is typically referred to as the charge code, description (Item Description), quantity used (Quantity), department that provided the care during which the catheter was used (Department), and the amount that was charged to the patient (Charge Amount). This information may be stored in a chargemaster data store.

For example, item 301 is one 2-way Foley catheter that the surgical department used during a procedure. Item 302 is one 3-way, non-latex Foley catheter that the Cardiac department used. The item descriptions for these two items provide additional information. For example, the item description for item 301 includes a manufacturer or distributor identifier in the description, “RCR13221.” Item 302 includes a manufacturer name, Bard, in the description. The identifier or manufacturer name in the description may be utilized subsequently to link the chargemaster data with purchase data. Alternatively, the identifier or manufacturer may be used to link to a best practice master data store.

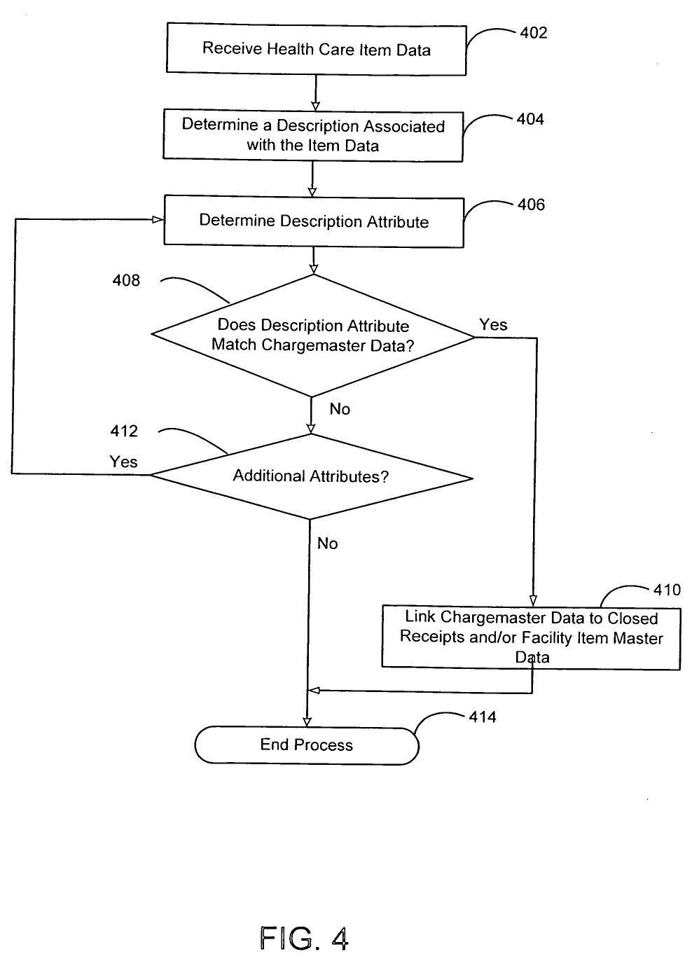

FIG. 4 is a flowchart illustrating a process for linking health care provision data and corresponding purchase data in one embodiment of the present invention. The process shown is described in relation to the system illustrated in FIG. 1 and the data tables shown in FIGS. 2 and 3. In the embodiment shown in FIG. 4, the link processor 120 receives health care item data 402. For example, the link processor 120 may execute a query against the facility closed receipts data store 128 or the facility item master data store 129 or both for items purchased on a particular day or within a particular time period. In response, the database server 108 provides a record set with the items satisfying the query. While the closed receipts 128 and facility item master 129 data stores are shown as separate data stores, in some embodiments, they may be combined into a single data store. Alternatively, the data in these two data stores may be physically present in numerous separate data stores. The same holds true for all of the data stores shown in FIG. 1.

The link processor 120 next determines the description associated with the item data for each record in the returned record set 404. Once the link processor 120 has determined the description associated with the item data, it determines an attribute associated with the item 406. The link processor 120 may determine the attribute in various ways. The link processor 120 may evaluate the description field in the data record for known product types. For example, in item id 205, the item description includes the term “Foley-cath.” The link processor 120 may refer to a list of known product names to determine that “Foley-cath” is a synonymous with “Foley Catheter.” Further, the link processor 120 may determine that the term “24 FR” in the description for item 205 corresponds to a size of the Foley catheter, or that the term “2-way” corresponds to a type of Foley Catheter. The link processor 120 may then determine that the unit id for item 205 is RCR13221.

The link processor 120 utilizes the attribute or attributes to attempt to link a charge to closed receipts and/or facility item master data 408. If the product attribute matches a purchase data record, the link processor 120 links the chargemaster data with the closed receipts and/or facility item master data 410. For example, the link processor 120 may determine that the item description for the chargemaster data matches a portion of the item master or closed receipts data for the purchase of item 301 in FIG. 3. Item 301 in FIG. 3 includes the text “RCR13221” in the item description, which matches the Unit ID of item 205 in FIG. 2.

A match does not have to be exact. For example, an item in the closed receipts or facility item master data store may include the exact same item description as a charge item (e.g., items 205 and 304). Alternatively, the item description of each may include the same information in a different order or using slightly different terms (e.g., “Foley catheter” and “cath-foley”). Or information in the item description of the closed receipts and chargemaster data may match on the basis of synonyms (e.g., “non-latex” and “silicone”). The degree of similarity required to determine whether a match occurs may differ for different types of products. For instance, if all the products of a certain type are similarly priced, regardless of size, the link processor 120 may find a match with less information than would be needed to determine that a match occurred between two items in which the price varies greatly and is highly dependent on size. For example, Foley catheters of different sizes are similar in cost. Accordingly, it may be enough to determine that a charge record is related to a Foley catheter without trying to determine that the record is related to a particular size of Foley catheter or to a Foley catheter made from a particular material.

If the current description attribute does not match the closed receipts data, then the link processor 120 determines whether or not additional attributes can be identified 412. For example, item 207 includes “all-silicone” in the description along with “Foley catheter.” If so, the link processor 120 repeats steps 406-412. If not, the process ends 414. For example, linking the chargemaster data to the closed receipts data may require more than one attribute in order to find a match. Alternatively, multiple items may appear to match the charge item until additional attributes are compared.

In the process shown in FIG. 4, the link processor 120 begins with item data and uses attributes of the item data to determine charge data. In other embodiments, the link processor 120 may begin with charge data and determines a link to item data. Other embodiments may also be implemented.

Once the process illustrated in FIG. 4 is complete, each record in the provision or chargemaster data of FIG. 3 links to a record in the purchase or closed receipts data shown in FIG. 2. In some embodiments, not all records are linked automatically. A table illustrating the links between the two tables in FIGS. 2 and 3 may appear as follows:

| Item ID | Charge ID |
|---|---|
| 205 | 301 |
| 207 | 302 |
| 206 | 303 |
| 205 | 304 |

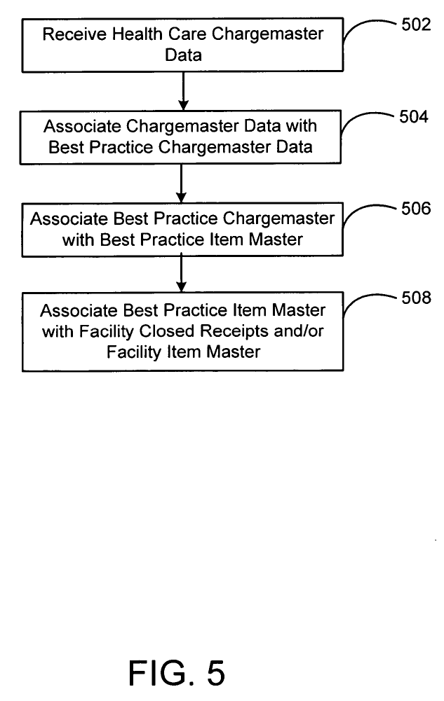

Although the link between the closed receipts and/or facility item master data and the chargemaster data may be direct, in some embodiments, the link is indirect, i.e., a virtual link exists between the two. FIG. 5 is a flowchart illustrating another process for linking healthcare provision data and corresponding purchase data in one embodiment of the present invention. In the process shown in FIG. 5, the link processor 120 received chargemaster data 502. For instance, the link processor 120 may extract records from the facility chargemaster data store 130 that have been added or updated since the link processor 120 last extracted data. When a service is provided, data regarding the service is created in the facility change data store 130.

The link processor 120 then links the received chargemaster data with corrseponding data in the best practice chargemaster data store (126) 504. The link processor may accomplish the association in various ways. For instance, in one embodiment, the link processor 120 utilizes the description in a manner similar to that shown in FIG. 4.

The link processor 120 also associates data in the best practice chargemaster data store 126 with data in the best practice item master data store 506. The association may be accomplished in numerous ways. For example, a hierarchical link may be created between the best practice chargemaster 126 and best practice item master 122.

Many chargemaster data records may be associated with each item master data record. Similarly, many item master data records may be associated with each chargemaster data record. In the embodiment shown in FIG. 1, the association between data in the best practice chargemaster data store 126 and best practice item master data store are stored in the charge item link data store 124. The charge item link data store 124 is similar in concept to the linking table shown above—it 124 includes records that comprise the unique identifiers (i.e., primary keys) from the master item 122 and master charge 126 data stores.

The link processor also associates the best practice item master 122 with the facility closed receipts data store 128 and may link best practice item master 122 with the facility item master 129 instead or as well 508. For example, when the health care facility purchases a Foley catheter, the link processor 120 determines to which best practice item master data store 122 to record the Foley catheter should be linked. In one embodiment, the link between the best practice item master and the closed receipts or facility item master is manual. The best practice item master data store 122 includes a list of many of the potential items the health care provider may purchase. Additional items may be added, and those new items are linked to the best practice chargemaster data store 126 when they are created.

Although the process shown in FIG. 5 illustrates a process moving linearly from receiving chargemaster data to linking facility item master data, the process may occur in different sequences. For instance, the links between the best practice chargemaster 126 and best practice item master 122 may be created before any data is created in the facility chargemaster 130 or closed receipts 128 data stores. The steps may also occur in parallel. For example, the links between the best practice item master 122 and closed receipts data store 128 may occur at substantially the same time as the links between the best practice charge master 126 and facility charge master 130. Each item in the closed receipts data store 128 may also be linked with items in the facility item master data store 129. And each item in the facility item master data store 129 may be linked with an item or items in the best practice item master 126.

The use of best practice data stores may simplify the linking of charge and purchase items since data created in the individual data stores is likely to be reused for similar procedures over time. For example, if the health care provider routinely refers to “cath-Foley” in charge record, this data may be more easily linked to a master charge item in subsequent procedures.

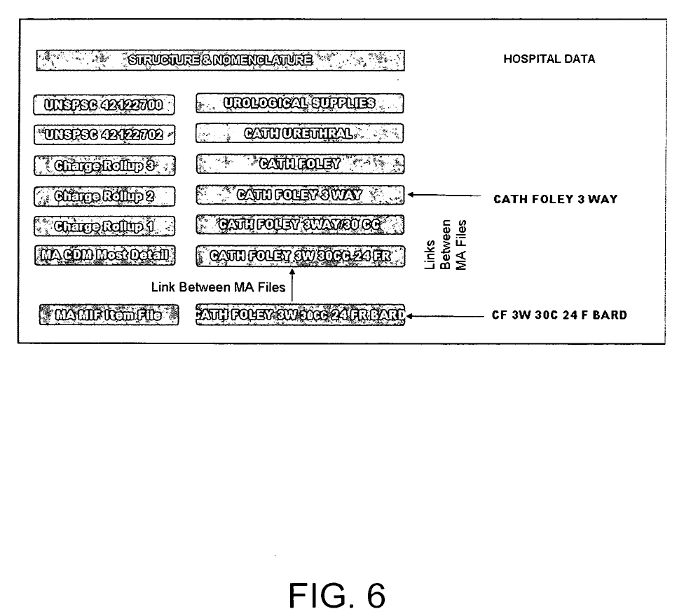

Providing best practice master item 122 and best practice master charge 126 data stores may also provide the capability of using an item or charge hierarchy. FIG. 6 is a block diagram, illustrating a charge hierarchy in one embodiment of the present invention. The hierarchy shown is a portion of the best practice chargemaster data store 126 shown in FIG. 1. The hierarchy shown is for a Foley catheter. The top level of the hierarchy is “urological supplies.” Many items may be classified as urological supplies, including urethral catheters (CATH URETHRAL). Other types of urological supplies may be present in the hierarchy. For simplicity, only one child of each level of the hierarchy is shown in FIG. 6.

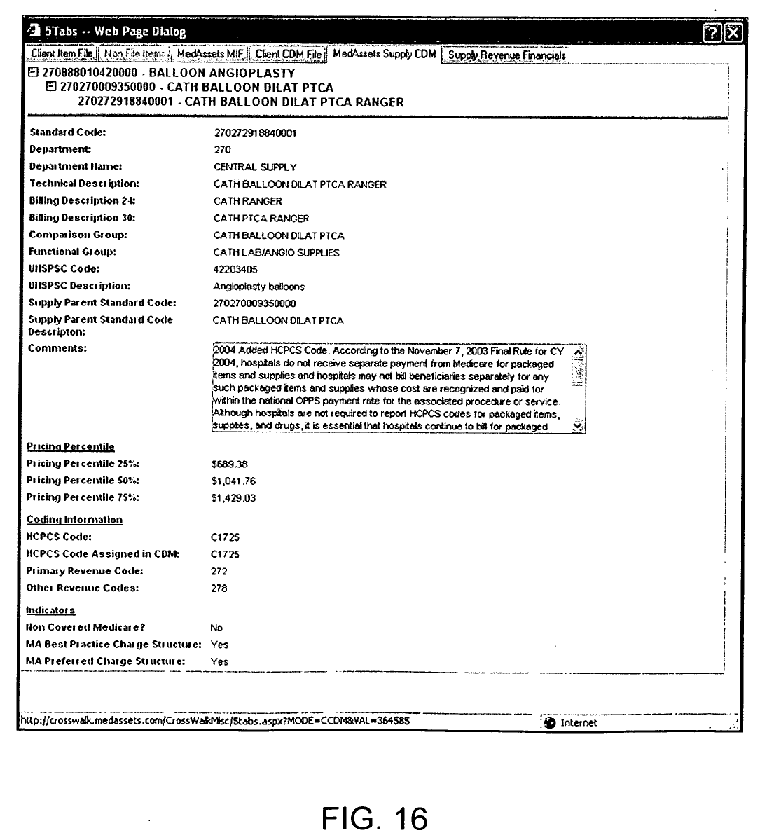

The quality of the links between the closed receipts or item master and chargemaster in the application are dictated by the mapping relationships that have been created using the best practice data structures. To begin with each item in the hospital closed receipts and/or item master is mapped in the best practice item file. Subsequently the item in the best practice item file is mapped to the best practice charge master at the most specific level. Finally all items in the hospital chargemaster are mapped to the best practice chargemaster. Once these mapping relationships have been established the application establishes the link between the hospital item master and charge master leveraging the best practice charge master's hierarchy (see FIG. 16) by literally analyzing the hierarchy and selecting the most appropriate item in that hierarchy which in theory should link to the most appropriate charge code in the hospital chargemaster (CDM). It should also be noted that if the item in question is not in the hospital's item master, then a separate link process is executed, linking all closed receipts (not associated with an item in the facility item file) to the appropriate charge code. The same process in leveraging the best practice charge master hierarchy is used.

Urethral catheters include Foley catheters (CATH FOLEY). Foley catheters include 3-way Foley catheters (CATH FOLEY 3 WAY), which includes various sizes. For instance, in the hierarchy shown in FIG. 5, the 3-way Foley catheter includes a 30 cc, 3-way Foley catheter (CATH FOLEY 3WAY 30 CC). In turn, the 30 cc, 3-way Foley catheter includes a 24 FR, 30 cc, 3-way Foley Catheter.

The hierarchy from the best practice chargemaster data store 126 is linked to the best practice item master data store 122. In the embodiment shown, the best practice item master data store 122 is linked to the best practice chargemaster data store 126 at the lowest level of the hierarchy. In this case, a 24 FR, 30 cc, 3-way Foley catheter manufactured by Bard is linked to the 24 FR, 30 cc, 3-way Foley catheter record in the charge hierarchy.

The best practice chargemaster data store 126 and best practice item master data store 122 are also linked to the facility's data stores—a hospital's data stores in the embodiment shown. The hospital data may be linked to the master data at any level in the hierarchy. In the embodiment shown in FIG. 5, the hospital chargemaster data is linked to the 3-way Foley catheter. No additional detail is present in the hospital data shown. The hospital may choose not to track additional detail if the costs of the various sizes of the 3-way Foley catheter are similar, i.e., it may not be worth the additional labor and time to track the chargemaster data more specifically. The hospital's purchase data is linked to the 24 FR, 30 cc, 3-way Foley catheter purchased from Bard.

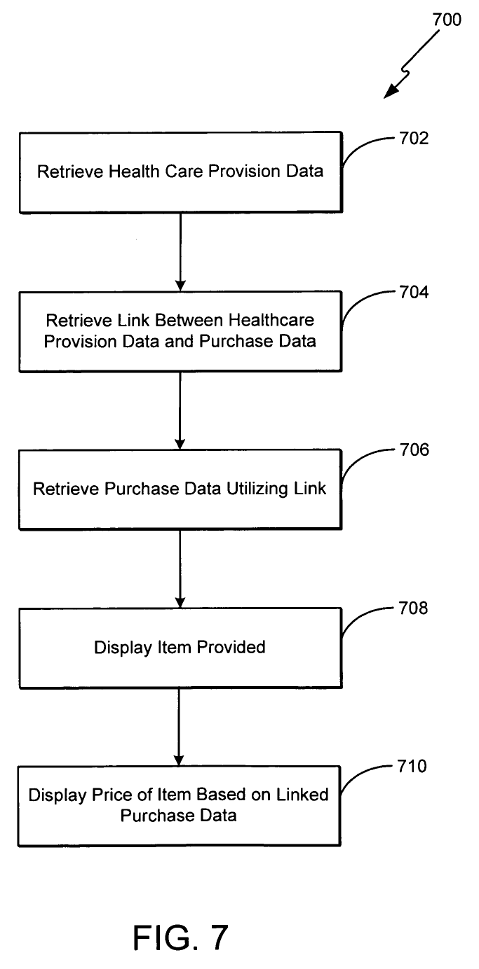

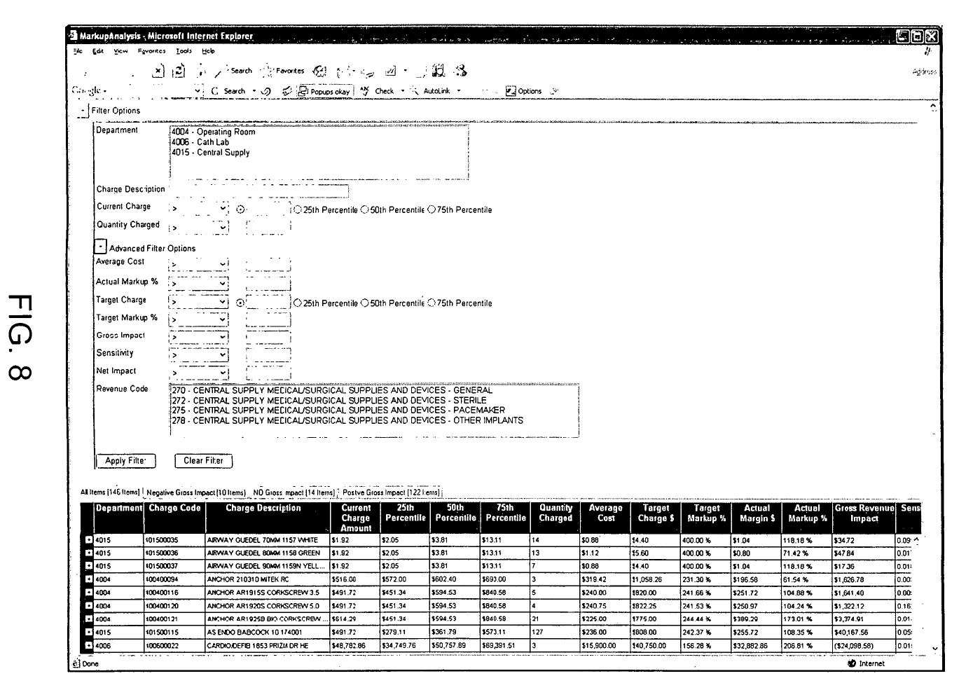

Since the master files are linked, the hospital files are linked as well, albeit indirectly. By linking the data in this manner, the hospital is able to track the cost of the Foley catheter when it is provided to a patient during provision of a medical service. FIG. 7 is a flowchart illustrating the creation of a supply-revenue link report provided in one embodiment of the present invention. The supply-revenue link report provides cost and charge data transparency. In the embodiment shown, a report engine (not shown) uses the links between the hospital's data to produce a report detailing the costs of products used during provision of a healthcare service. The report may also provide charge data in addition to or instead of cost data.

The reporting process 700 begins by retrieving health care provision data (chargemaster data) 702. The report engine then retrieves the link between the healthcare provision data and purchase data 703. For example, the report engine may retrieve all charge records for hospital for a single day from the facility chargemaster data store 130. For each record retrieved, the report engine then determines to what record in the best practice chargemaster data store 126 the retrieved record relates (shown in FIG. 5).

The report engine then retrieves purchase data utilizing the link 706. For example, if a Foley catheter is present in the chargemaster data record, the report engine retrieves the Bard Foley catheter from the facility closed receipts data store 128.

The report engine then displays the item provided in the report 708. The description may come from the chargemaster data report or the item master data record or some combination of both. The report engine then displays the price of the provided item based on the price of the item stored in the facility closed receipts data store 128.

While the illustrative embodiments described above are described in terms of a single facilities item master and chargemaster, embodiments of the present invention may also be utilized across multiple facilities. For instance a vendor of a product, such as an artificial hip, may wish to track the charges and corresponding cost for artificial hips used in multiple facilities. In addition the vendor may want to also track the cost and charge of a comparable item by a vendor and how different facilities maybe pricing similar items. In one such embodiment, multiple facility item data stores are linked to a best practice item data store. And multiple facility chargemaster data stores are linked to a best practice chargemaster data store, which is in turn linked to the best practice item store. Since the chargemaster and item master data is linked across facilities, the vendor is able to summarize, compare, and contrast the charge and cost data across the various facilities.

### Illustrative Reports

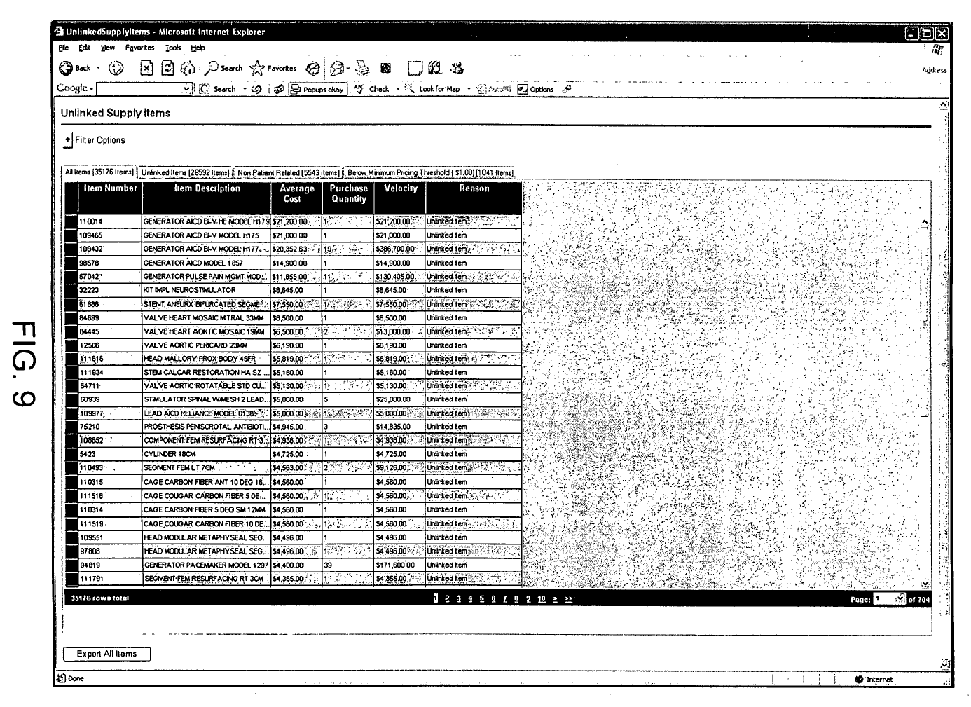

FIG. 8 is a screen shot illustrating a markup analysis report in one embodiment of the present invention. The markup analysis report illustrates the charge to cost relationship of items and how consistently a hospital's markup formula is being applied. The report allows users to see what item or items in the item file are rolled up under a single charge (by clicking on the “+” sign). This provides facilities with greater visibility into what makes up their average weighted cost and, perhaps more importantly, whether there are wide cost variances on items linked to a single charge code. The report shown includes a department column. In one embodiment of the present invention, each department in a hospital (e.g., Radiology) has a specific department number associated with it. Hospitals typically like to track what department is charging for what item. It is not uncommon to have an item listed multiple times. It is also common for an item to be listed multiple times across different departments

The report also includes a charge code. The charge code is associated with the charge of the following item. This is a unique code that the hospital assigns to each item. Depending upon the patient accounting system, the first four digits may, as in this case, represent the department while the last four digits represent the service item (service). In some embodiments, there is no relationship between the charge code and the particular department or service item.

The report also includes a description column. This is the description given by the hospital to that particular item. These items may be very specific and refer to one item; however, it is not uncommon for the descriptions to be general so they can be used to charge for different items (for examples items that vary in size).

The report shown in FIG. 8 also includes a current charge amount, which is the current amount the hospital is charging for an item according to their chargemaster. The report also includes a quantity charged column—the quantity that has been charged for over a fixed period of time. In one embodiment, the value in this column represents the volume over the entire fiscal year.

Te report also includes an average cost column, which is the weighted average cost. Since an item in a chargemaster may be associated with multiple items in an item master, an average cost weighted towards volume is used to determine actual cost. In one embodiment, the average cost is calculated as SUM(Cost*Quantity)/SUM Quantity.

The report also includes a target charge amount. The target charge is based on what a hospital should be charging for an item if they were following their proposed markup formula. This is based on a hospitals specified markup formula, which may vary widely based on the hospital or even within a hospital. The report also includes a target charge percentage. The column illustrates the target charge increase as compared to the average cost, i.e., what percentage a hospital is marking that item up based on their markup formula. In one embodiment, the target charge percentage is calculated as (([Target Charge Amount]−[Average Cost])/[Average Cost])*100.

The report also includes a margin on a per item basis and an actual markup percentage. The actual margin percentage illustrates the actual markup % that is being applied at a facility. This percentage is often consistent with the proposed markup and is calculated as (([Actual Charge Amount]−[Average Cost])/[Average Cost])*100),

The report also includes a gross revenue column. The gross revenue indicates how much more money this facility would be bringing in on that item if they had followed their proposed markup and is calculated as (Target Charge−Actual Charge Amount)*Quantity Charged.

The report also includes sensitivity and net revenue impact columns. The sensitivity illustrates how responsive an item is to a price change based on the agreement the hospital has with various payers. For example, if an item has a sensitivity of 0.091499, every dollar the price of that item increases will net the hospital approximately 9 cents. The sensitivity formula varies based on facilities reimbursement agreements with various payers. The net revenue impact indicates how much money the hospital will actually net once the price change is implemented and the sensitivity is applied and is calculated as (Gross Revenue*Sensitivity).

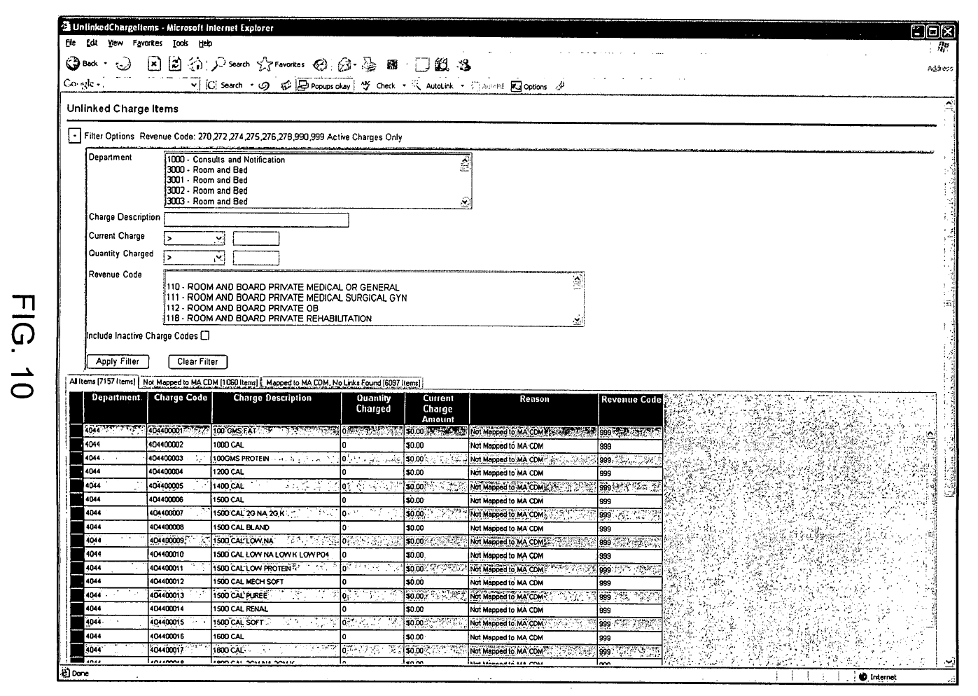

FIG. 9 is a screen shot illustrating an unlinked supply items report in one embodiment of the present invention. This report details supply items that have not been linked to the chargemaster. This report may reveal items that a hospital may not be charging for but should be charging for. The report shown includes an item number, which is the unique number a hospital assigns to a supply. The item number is stored in the facility item master data store 130, which is part of a hospital's material management system (MMS). The report also includes an item description, the description of the item contained in the facility item master 130. This description may be very specific.

The report also includes average cost and purchased quantity. The average cost is the average cost for an item over a specified time frame. The report also includes a purchased quantity, which is the quantity of that particular item that was purchased over a specified time period.

The report also includes a reason column. The reason column describes the reason why a link to the chargemaster was not established. In this report, the tabs represent various reasons why a link may have not been established. The data associated with the three reasons may be viewed by clicking on one of the three tabs: (1) the system was unable to map to best practice master item data; (2) The item was not related to patient care; and (3) the system was unable to generate a link and find a corresponding charge item in the best practice chargemaster 126 (this may indicate an item that was not charged for).

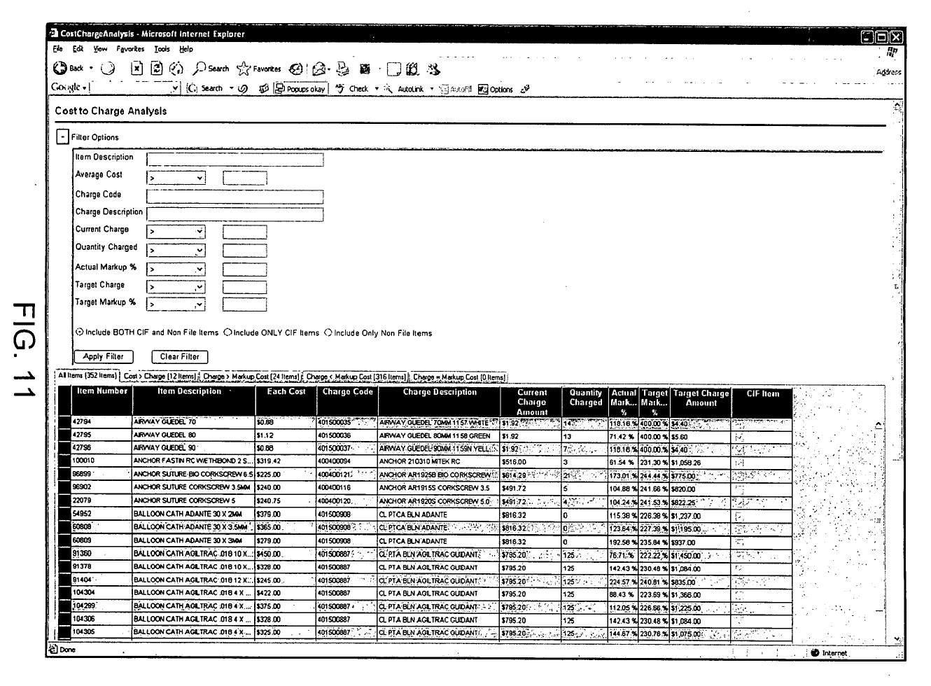

FIG. 10 is a screen shot illustrating an unlinked charge items report in one embodiment of the present invention. The unlinked charge report reveals charges for items for which there have been no linkages established to the facility item master. This report may indicate items that a hospital is under charging and/or over charging for since the price is not based on the cost of the item. The report shown includes a department, charge code, and charge description as described above.

The report also includes a year-to-date (YTD) volume (e.g., the facility's fiscal year-to-date), the number of items that have been charged over a 12-month period. The report also includes the current charge amount.

The report also includes a reason column. The reason column provides a reason why a link to the facility item master 128 was not established. In the report shown in FIG. 10, there are 2 reasons why a link may have not been established and they can be individually viewed by clicking on one of the three tabs: (1) The charge was not able to be mapped to the best practice chargemaster 126; and (2) the system was unable to generate a link and find a corresponding supply item in the facility item master 128.

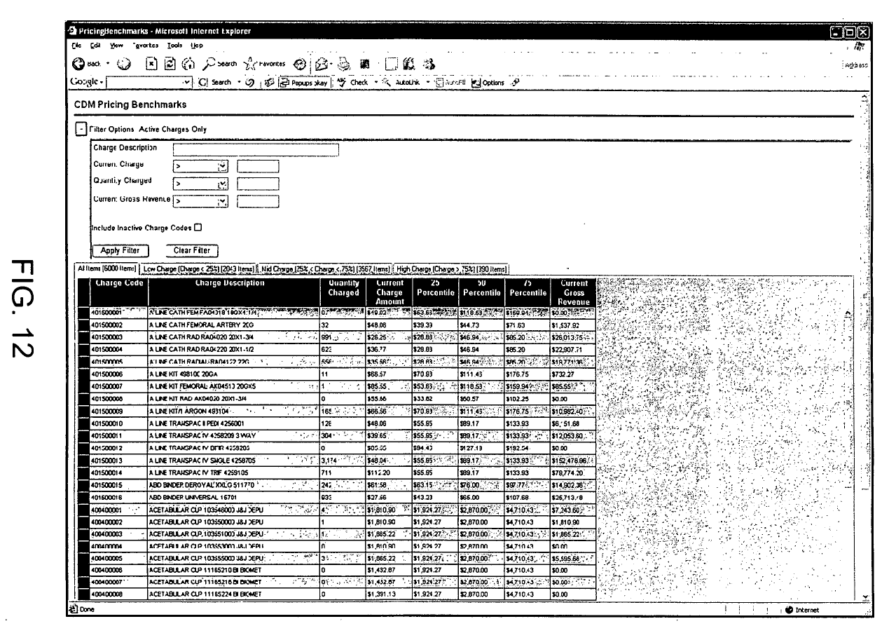

FIG. 11 is a screen shot illustrating a cost-to-charge analysis report in one embodiment of the present invention. This report illustrates the relationship of cost to charge and how consistently a facility's markup formula is being applied. However, unlike the markup analysis report, which utilizes the charge (which is a weighted average of multiple items), this report illustrates the markup as it compares to each individual item in the facility item file. This report provides a comparison of actual markup to target markup. The report includes an item number and item description column as described above. The report also includes an each cost column, which is the average cost for an item during a specified time period. This report also differentiates between items that are in the item master and items that are not in the item master (non file items). This is crucial data element because many of the items that are not on markup traditionally are non-file items.

The report also includes charge code, charge description, current charge amount, quantity charged, and client item file flag columns as described above.

The report includes an actual markup percentage, which is the actual markup percentage applied at a facility, which is calculated as (actual %=(([Actual Charge Amount]−[Average Cost])/[Average Cost])*100).

The report also includes target markup percentage and target charge amount columns. The target markup % illustrates the target charge increase as compared to the average cost (what's the % a hospital is marking that item up based on their markup formula) and is calculated as (([Target Charge Amount]−[Average Cost])/[Average Cost])*100. The target charge amount is based on what a hospital should be charging for an item if they were following their proposed markup formula.

The report includes various tabs, including (1) all items; (2) cost of the item exceeds that charge; (3) charge exceeds the proposed hospital markup %; and (4) cost of items exceeding the charge and/or charge is below proposed markup formula.

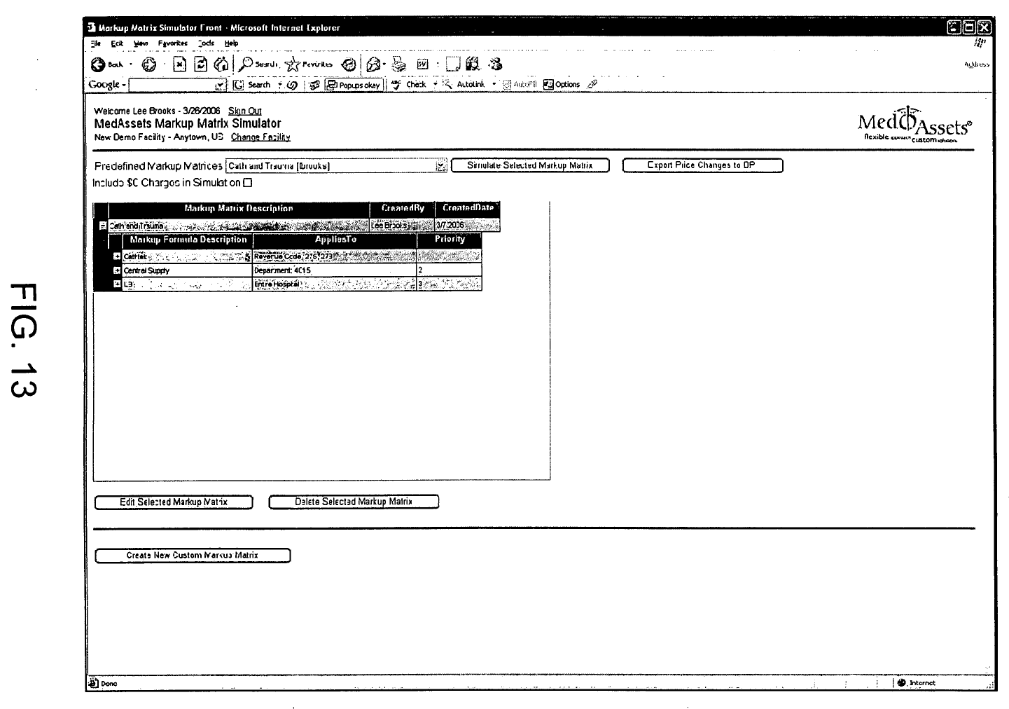

FIG. 12 is a screen shot illustrating a chargemaster benchmark report in one embodiment of the present invention. This report facilitates a facility's understanding of their markup formula and how it impacts a facility's pricing in relation to other hospitals. This report determines a price range for a particular item and divides that range into three pricing percentile buckets at the 25th, 50th, and 75th percentile. Items included in this report are associated with at least five hospitals. In some embodiments, the data included in the report is at least ninety days old.

The report shown includes charge code, charge description, usage during a specified period, and current charge amount columns as described above. The report also includes 25th, 50th, and 75th percentile columns. The data contained within these columns, in some embodiments, represent benchmark prices developed from a national database of hospital charge amounts.

The report also includes a current gross revenue column. This column indicates the gross revenue associated with that item based upon the current charge amount and the usage during a specified time period.

The report shown includes four tabs: (1) all items; (2) items priced that fall at or below the 25th percentile benchmark; (3) items that are priced between the 25th and 75th percentile benchmarks; and (4) items that are priced above the 75th percentile benchmarks.

All reports include reporting filter options that allow users to filter on specific subsets of data. The reporting filter options in most cases are consistent with the fields within each report. Users also have the option of exporting any report to excel if they would like to manipulate the data more extensively.

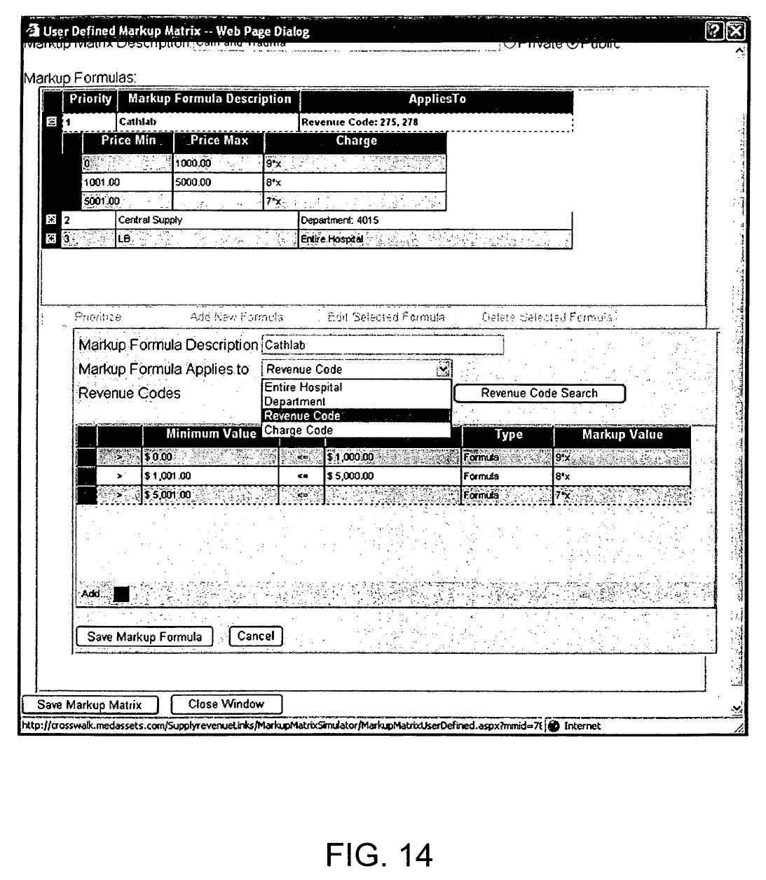

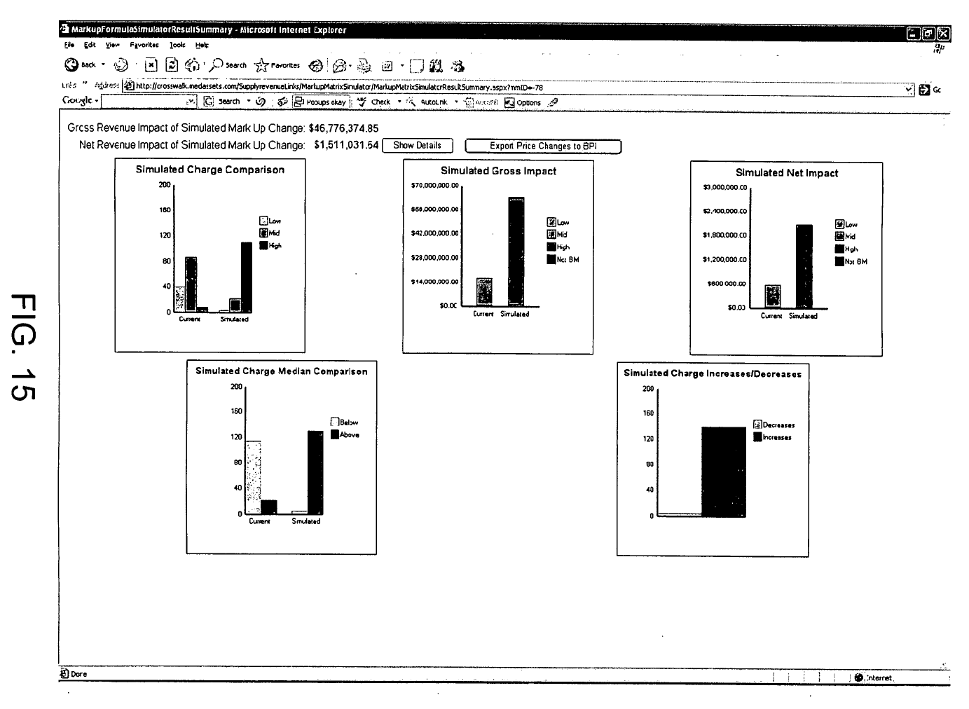

FIGS. 13-15 are screen shots illustrating a markup simulation tool in one embodiment of the present invention. The simulation tool shown is a Markup Formula Simulator. The Markup Matrix Simulator allows for a hospital in real time to measure the gross and/or net revenue impact based on a specific alternate markup formula. This is done by integrating payer/reimbursement information into the simulation. The payer reimbursement information is represented by assigning price elasticity (sensitivity price change) with each individual item in the chargemaster. Consequently this allows the markup simulator to more precisely represent the amount of net revenue associated with a specific price change. The Markup Matrix Simulator provides optimal flexibility in creating a markup strategy by allowing users to create various formulas based on the acquisition cost of the item. Hence the simulator makes it much easier for a facility to migrate to a more defensible pricing structure by tying the markup to the acquisition cost of the item. Users have the option of utilizing one of many pre-defined markup formulas, which are provided as part of the application, or they can create custom markup formulas. In addition, the simulator provides for very granular control, allowing it to be applied to an entire hospital, a specific department, a specific charge code or a specific revenue code. Users may also create one simulation with different markups assigned to different segments of the hospital. In addition to providing the overall gross/net impact of applying a different markup, a user can view the impact of a markup formula change down to the item level.

While several of the reports and tools above are shown and leveraged in relation to a single facility to better understand their pricing and markup strategy, the data may also be used by vendors to better understand their pricing strategy and how it compares to other vendors items in that same market space. For example, a vendor may use the benchmark report illustrated in FIG. 12 to better understand the markup formula(s) applied to their products and how the markup formula(s) impacts a facility's pricing of the vendor's products.

FIG. 16 is a screen shot illustrating an interface for viewing at what level an item in the facility charge master is linked to in one embodiment of the present invention. The data shown in the interface includes standard codes, descriptions, and prices for various items. The interface also illustrates a portion of the chargemaster hierarchy.

### General

The foregoing description of the embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

That which is claimed:

1. A method for health-care resource management, the method comprising:
associating provision data with a charge item in a standardized chargemaster data store arranged as a hierarchy, the provision data associated with provision of a health care-related service by a health-care provider and having a product identifier associated with a product;
associating the charge item with a purchasable item in a standardized item master data store, the purchasable item associated with the health care-related service;
associating purchase data with the standardized item master data store, the purchase data associated with the health-care related service; and
associating the provision data with the purchase data based at least in part on the hierarchy of the standardized chargemaster.

2. The method of claim 1, wherein the product comprises a first product and further comprising determining a second product associated with the purchase data, the second product having a product attribute.

3. The method of claim 2, wherein the product attribute comprises at least one of a name, a product identifier, a uniform product code, a description, and a purchase date.

4. The method of claim 1, further comprising determining a cost of goods sold for the product.

5. The method of claim 1, wherein an inventory management system comprises the purchase data.

6. The method of claim 1, further comprising associating the provision data with a closed receipt data store.

7. The method of claim 1, further comprising:
receiving at least one markup formula; and
applying the at least one markup formula to the provision and purchase data; and
determining a revenue impact caused by application of the at least one markup formula.

8. The method of claim 7, wherein the at least one markup formula comprises a net revenue sensitivity measure.

9. The method of claim 8, wherein the net revenue sensitivity measure is associated with the charge item.

10. The method of claim 7, wherein the at least one markup formula comprises a pre-defined markup formula.

11. The method of claim 7, wherein at least one the markup formula comprises a custom markup formula.

12. The method of claim 7, further comprising causing the revenue impact to be output.

13. The method of claim 7, wherein the at least one markup formula is associated with one of a hospital, a specific department within the hospital, a specific charge code, or a specific revenue code.

14. The method of claim 7, wherein the at least one formula comprises a plurality of markup formulas, each of the plurality of markup formulas associated with a different department within a hospital.

15. A computer-readable medium on which is encoded program code for health-care resource management, the program code comprising:
program code for associating provision data with a charge item in a standardized chargemaster data store arranged as a hierarchy, the provision data associated with provision of a health care-related service by a health-care provider and having a product identifier associated with a product;
program code for associating the charge item with a purchasable item in a standardized item master data store, the purchasable item associated with the health care-related service;
program code for associating purchase data with the standardized item master data store, the purchase data associated with the health-care related service; and
program code for associating the provision data with the purchase data based at least in part on the hierarchy of the standardized chargemaster.

16. The computer-readable medium of claim 15, wherein the product comprises a first product and further comprising determining a second product associated with the purchase data, the second product having a product attribute.

17. The computer-readable medium of claim 15, further comprising determining a cost of goods sold for the product.

18. The computer-readable medium of claim 15, further comprising associating the provision data with a closed receipt data store.

19. The computer-readable medium of claim 15, further comprising:
receiving at least one markup formula; and
applying the at least one markup formula to the provision and purchase data; and
determining a revenue impact caused by application of the at least one markup formula.

20. The computer-readable medium of claim 19, further comprising causing the revenue impact to be output.

21. A system for health-care resource management, the system comprising:
means for associating provision data with a charge item in a standardized chargemaster data store arranged as a hierarchy, the provision data associated with provision of a health care-related service by a health-care provider and having a product identifier associated with a product;
means for associating the charge item with a purchasable item in a standardized item master data store, the purchasable item associated with the health care-related service;
means for associating purchase data with the standardized item master data store, the purchase data associated with the health-care related service; and
means for associating the provision data with the purchase data based at least in part on the hierarchy of the standardized chargemaster.
